(19) United States
(12) Patent Application Publication
(10) Pub. No.: US 2010/0068361 A1
(43) Pub. Date: Mar. 18, 2010

(54) CUP WITH SPACE FOR ACCOMMODATION OF PAD

(75) Inventors: Cornelis Margaretha Theodorus Maria Bongers, Helmond (NL); Wiebe Nicolaas Van Druten, Zeewolde (NL)

Correspondence Address: SUGHRUE MION, PLLC, 2100 PENNSYLVANIA AVENUE, N.W., SUITE 800, WASHINGTON, DC, 20037, US

(73) Assignee: FRIESLAND BRANDS B.V., Meppel (NL)

(21) Appl. No.: 12/514,984

(22) PCT Filed: Dec. 10, 2007
(86) PCT No.: PCT/NL2007/050640

§ 371 Date: Jun. 26, 2009

(30) Foreign Application Priority Data
Dec. 22, 2006 (NL) 2000399

(51) Int. Cl. A47J 31/00; A23F 5/26

(52) U.S. Cl. 426/431; 99/295

(57) ABSTRACT

Cup for the preparation of a liquid product, having an inlet opening provided with a covering layer (16) with liquid-permeable perforations (17, 18, 19) for receiving a liquid suitable for a first preparation substance to be placed in the cup. The cup (10) furthermore has an outlet opening (24) for discharging the prepared beverage or dish, and a static mixer (5) which is in liquid communication with the outlet opening. On the side of the inlet opening the cup (10) is provided with a raised edge (65) on the circumference which extends to a predetermined distance (a) above the covering layer (16), so that a space for the accommodation of a body (60) filled with a second preparation substance is produced on the upper side of the cup (10).

### FIELD OF THE INVENTION

The present invention relates to a cup for the preparation of a liquid product, comprising an inlet opening provided with a covering layer with liquid-permeable perforations for receiving a liquid suitable for a first preparation substance to be placed in the cup, and an outlet opening for discharging the prepared beverage or dish.

### Prior art

Cartridges for use in the preparation of hot beverages based on a liquid concentrate are known, inter alia from WO-A-01/58786, EP-A-0 449 533, EP-A-1 101 430, WO-A1-03/073896, WO-A1-03/053200, WO-A1-02/19875, U.S. Pat. No. 6,130,990, U.S. Pat. No. 4,886,674, EP-A-1 440 907 and EP-A-1 440 908.

A shape-retaining pad for the preparation of hot beverages is disclosed in EP-A-1 398 279. The pad described comprises a shape-retaining housing containing a water-soluble constituent such as milk powder, creamer and/or sugar. The shape-retaining housing furthermore comprises internal parts which divide the shape-retaining pad, as it were, into a large number of vertically directed chambers. The shape-retaining pad can be used together with an ordinary pad (extraction pad, for example a coffee pad) in a preparation machine, for example for making cappuccino. Various variants are described, but a shape-retaining pad with vertically directed chambers is always used in combination with an extraction pad, which pads are placed above one another. Uniformly distributed over the upper surface of the shape-retaining pad, the liquid (hot water or coffee from the extraction pad) is forced through the pad under some pressure. A disadvantage is that this does not result in all of the constituents present in the shape-retaining pad being dissolved. The residues left behind are therefore thrown away unused, with the result that this method of beverage preparation is not efficient.

WO-A-01/58786 and EP-A-0 449 533 disclose a cartridge in which hot water is conveyed through a pointed inflow opening on the underside of the cartridge by way of a ‘ring line’ containing distribution openings, and also by way of said distribution openings through a compartment containing a concentrate, the water diluting the concentrate to a beverage by means of turbulence, which beverage is then conveyed by means of a siphon to an outflow opening on the underside of the cartridge.

EP-A-1 101 430 discloses a stepped cartridge in which, inter alia, provisions are included for using a liquid concentrate (paras [0034] and [0035]). For use of this cartridge the wall of the cartridge is pierced, after which hot water is conveyed through the concentrate by way of the inflow opening(s) thus created, thereby diluting the concentrate to a beverage, said beverage leaving the cartridge by way of a likewise pierced outflow opening.

WO-A1-03/073896 discloses a cartridge in which the underside of the cartridge is provided with perforations and is covered with a foil, which foil has to be removed before use. This cartridge also is suitable for a liquid concentrate (p. 14, lines 3-8 and Claim 18), hot water being conveyed through the concentrate from an inflow opening on the upper side, thereby diluting the concentrate to form a beverage, said beverage leaving the cartridge by way of the preformed perforations on the underside.

WO-A1-03/053200 and WO-A1-02/19875 disclose cartridges made of a flexible material, which cartridges are suitable for, inter alia, a liquid concentrate (WO-A1-03/053200, p. 5, lines 19-21; WO-A1-02/19875, p. 19, lines 4-6) for use in a water heater, the cartridge being clamped in a cavity designed for it and being pierced by a hollow needle, after which the water is conveyed through the concentrate to the outflow opening.

U.S. Pat. No. 6,130,990 discloses a water heater which is suitable for preparing a beverage based on concentrate in a cartridge (col. 5, lines 54-57; col. 7, lines 58-61; col. 9, line 66—col. 10, line 6).

U.S. Pat. No. 4,886,674 discloses a cartridge made of a flexible material, which cartridge is suitable for, inter alia, a liquid concentrate, the water supply being conveyed by way of a connection point through the concentrate to an outflow opening, which outflow opening is created by a weakened sealing seam, which sealing seam is opened by the working pressure of the machine.

European patent applications EP-A-1 440 907 and EP-A-1 440 908 disclose a cartridge for use in the preparation of beverages. This cartridge is dome-shaped and is sealed on the underside by means of a foil, and on the foil side is provided with both an inlet opening (on the edge) and an outlet opening (in the middle). Water (hot water) is conveyed by way of a pointed inflow opening on the underside of the cartridge and by way of a ‘ring line’ containing distribution openings against the sealing foil, and also by way of said distribution openings through a compartment. The compartment contains a concentrate, and the water dilutes the concentrate to a beverage by means of turbulence, which beverage is then conveyed by way of a siphon to an outflow opening on the underside of the cartridge. Special measures are also in place in the cartridge to ensure that the water runs evenly from the inlet opening in a radially inwardly directed manner through the interior space of the cartridge.

In a further embodiment EP-A-1 440 907 discloses a method for controlling the mixing of the water with the concentrate by means of provisions which delay the mixing of the concentrate with the water. In this case this provision is in the form of a sort of plate, the concentrate being added to the flow path of the water in a delayed manner through the holes on the underside of the plate.

None of the cartridges discussed above can be used in a water heater suitable for extraction pads made of filter material, so that it is necessary to use a preparation machine specially designed for these respective cartridge types. In particular, the connection of the inflow point on the cartridges means that water heaters that are suitable for extraction pads made of filter material are unsuitable for the abovementioned cartridges.

It is pointed out that a cup such as that referred to in the preamble above is disclosed in PCT/NL2006/050144, an application which is not a prior publication.

### SUMMARY OF THE INVENTION

The aim of the present invention is to provide an improved cup or cartridge for the preparation in particular of hot products such as a cappuccino which can be used in combination with components that are known per se for the preparation of products such as beverages.

To this end, according to the present invention, a cup of the type mentioned in the preamble is provided, in which the cup furthermore comprises a static mixer which is in liquid communication with the outlet opening, on the side of the inlet opening the cup being provided with a raised edge on the circumference which extends to a predetermined distance above the covering layer, so that a space for the accommodation of a body filled with a preparation substance is produced on the upper side of the cup. This body can be an extraction pad or a coffee pad, with a filter material as the outside, such as non-woven material, perforated plastic etc. The inside can be filled with loose extraction material (for example extraction granules, ground coffee etc.), but the body can also be in the form of a sponge with concentrate. The raised edge provides space for the accommodation of such a body, and the covering film in combination with the static mixer provides a support for this body. This provides a simple way of using existing preparation equipment to prepare a more complex product by adding a first preparation substance. Since this is done with a cup with the structure described, preparation is very efficient, and virtually no preparation substance is wasted.

In one embodiment the cup is closed on the upper side by means of a removable sealing layer, which can be removed before use. The sealing layer ensures that no preparation substance is lost during transport and/or storage of filled cups. In order to be able to remove the sealing layer easily, said sealing layer in a further embodiment is provided with a projection extending beyond the edge, for example in the form of a projecting lip.

The raised edge in one embodiment furthermore comprises a supporting edge for the body filled with a preparation substance. This ensures that even better support of the body occurs, even when liquid is forced through the body under pressure during use.

The first preparation substance with which the cup can be filled in one embodiment comprises a beverage concentrate, for example a milk concentrate, a creamer concentrate, a flavouring concentrate, a sugar concentrate etc. The beverage concentrate can also comprise a combination of the abovementioned sorts. This makes it possible to prepare much more complex beverages with the present cup in combination with an existing extraction pad.

In a further aspect the present invention relates to the use of a cup according to the present invention in a preparation machine provided with an accommodation space for accommodating the cup with a first preparation substance and a body filled with a second preparation substance, the preparation machine being equipped to convey a liquid (such as hot water) through the body and the cup.

### BRIEF DESCRIPTION OF THE DRAWINGS

The present invention will now be discussed in more detail on the basis of a number of exemplary embodiments, with reference to the appended drawings, in which:

FIG. 1 shows a cross-sectional view of a cup for the preparation of a product;

FIG. 2 shows a cross-sectional view in perspective of the cup according to FIG. 1;

FIG. 3 shows a cross-sectional view of a combination of a cup according to one embodiment of the present invention with an extraction pad prior to use;

FIG. 4 shows a cross-sectional view of the cup and extraction pad according to FIG. 3 during use; and

FIG. 5 shows a disassembled perspective view of a cup according to one embodiment of the present invention in combination with an extraction pad.

### DETAILED DESCRIPTION

With the cup 10 according to the present invention it is possible to prepare (hot) beverages, such as hot cappuccino, with a preparation machine (and possibly an accompanying holder for the cup). To this end, the cup (also known as a cartridge or reservoir) is filled with a concentrate, which by means of the machine is mixed with hot water and dispensed into a cup or mug. Other beverages or dishes can also be prepared on the basis of a concentrate or another preparation substance, milk products, fruit juices, sauces and desserts.

The preparation substance is a product that can be dissolved or suspended in a liquid, and can be a powder, a liquid (concentrated), a syrup, a gel or another similar type of product. If a powder is being used, said powder preferably does not contain any difficultly soluble or insoluble substances (such as certain proteins), so that good mixing with the hot water in the cup is ensured. It is possible, for example in the embodiment of the cup 10 with a number of chamber parts to be described later, to use combinations of preparation substances, even a combination of a concentrate and a powder.

The cup 10 can be used with different fillings in the same preparation machine, thus producing the possibility of preparing several types of products, such as hot and cold beverages, with one machine.

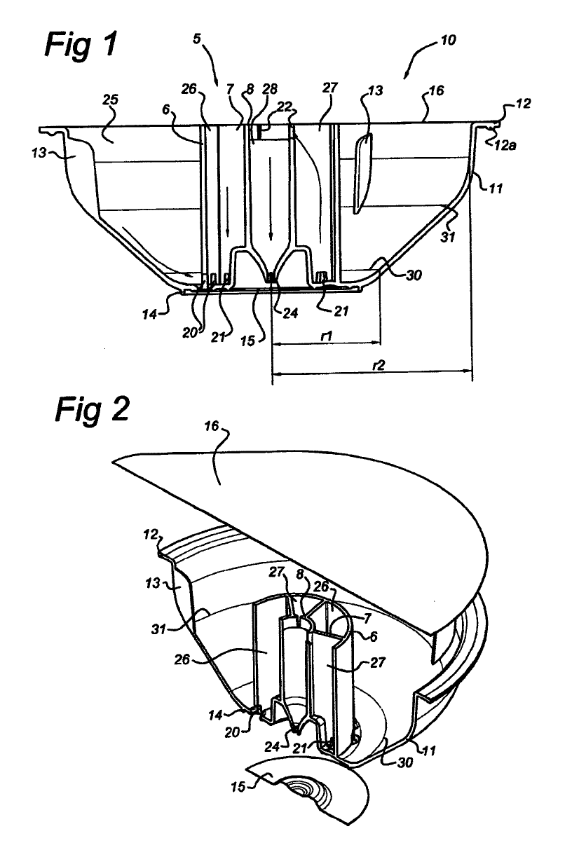

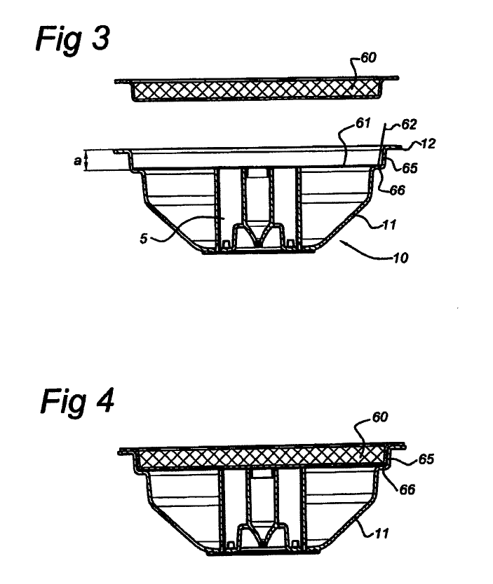

FIGS. 3, 4 and 5 show a number of embodiments of a cup 10 according to the present invention. The structure of the cup 10 and its mode of operation are explained in more detail later with reference to FIGS. 1 and 2.

FIG. 3 shows a cross-sectional view of a cup 10, with a shell 11 and a static mixer 5 situated in the centre of the shell 11. On the upper side of the cup 10 the rim 12 is adapted compared with the embodiments shown in FIGS. 1 and 2, in that a raised edge 65 is present. In this way a space is formed on the upper side of the cup 10, in which space a body 60 filled with a preparation substance can be placed. The body filled with a preparation substance can be, for example, an extraction pad (coffee pad), in which a preparation substance is present between two water-permeable layers (as is known to the person skilled in the art). The body 60 can also have a filter material such as non-woven material, perforated plastic and the like as the outside. The inside can be filled with loose extraction material (for example extraction granules, ground coffee etc.), but the body can also be in the form of a sponge with concentrate. The height of this space is indicated by the letter a in FIG. 3, and is sufficient for the accommodation of an extraction pad 60. The position and dimensions of the rim 12 of the cup 10 in one embodiment are such that said rim can connect to an edge of the extraction pad 60.

The upper side of the cup 10 is sealed for transport and storage by a sealing layer 61, which is situated directly above the covering layer 16 (see FIGS. 1 and 2 below). The sealing layer 61 is removed from the cup 10 before operation (placing of the cup 10 in a preparation machine), after which the extraction pad 60 can be placed.

In order to make removal of the sealing layer 61 easier, said sealing layer is provided on the edge with a projection 62, for example in the form of a lip.

FIG. 4 shows a cross-sectional view of an assembly of cup 10 and extraction pad 60, in which it can be seen that the extraction pad 60 fits precisely into the space defined by the raised edge 65. Furthermore, the extraction pad 60 is supported by the covering layer 16 and the upper edge of the static mixer 5. This means that the extraction pad 60 remains nicely horizontal during operation, even when liquid is being forced under pressure through the extraction pad 60 out of the preparation machine. In the embodiment shown in FIGS. 3 and 4, in order to improve the support of the extraction pad 60, a supporting edge 66 is also provided in the shell 11. As a further alternative, additional supporting ribs can be provided on the inside of the shell 11, on which supporting ribs the extraction pad 60 rests.

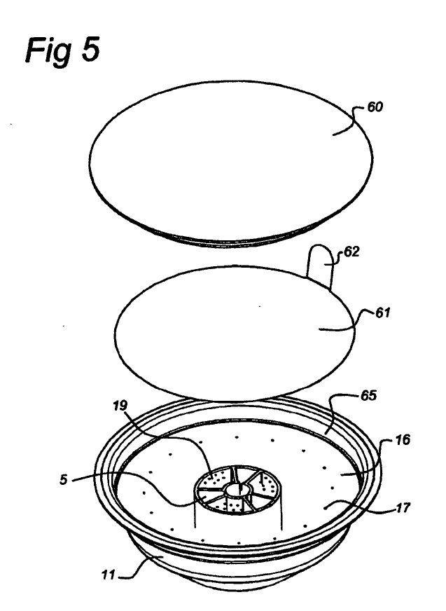

FIG. 5 shows a disassembled perspective view of one embodiment of the cup 10 according to the present invention. In FIG. 5 the covering layer 16 is shown as if it were transparent, so that the static mixer 5 is visible on the inside of the cup 10. Clearly visible is the sealing layer 61 with lip 62, which has to be removed from the cup 10 before use, after which the extraction pad 60 can be placed in the space defined by the raised edge 65.

The cup 10 can be filled with a first preparation substance, and the extraction pad 60 with a second preparation substance (for example a quantity of ground coffee). The first preparation substance can be a concentrate for beverage preparation. In the case of a coffee pad 60 this can be, for example, a milk concentrate, a creamer concentrate, a sugar concentrate, or a flavouring concentrate. As described with reference to FIGS. 1 and 2, the cup 10 can also comprise more than one type of preparation substance.

FIG. 1 shows a cross-sectional view of a cup 10 according to one embodiment of the present invention. FIG. 2 shows a cross-sectional view in perspective of the outflow part of the cup according to the embodiment of FIG. 1. The cup 10 has a shell 11 with a rim 12 on the upper side. The rim 12 can furthermore be provided with a sealing edge (not shown), which in combination with a holder, for example, provides a seal of the assembly of holder and cup 10, so that water is forced out of the machine through the cup 10. The sealing edge can also be provided as part of the holder or of the preparation machine.

The bowl-shaped underside 11 is furthermore provided with an edge 14. The bowl-shaped underside 11 is sealed inside the edge 14 by a seal 15 for transport and storage. The seal 15 is, for example, a plastic seal which is suitable for use in combination with foods.

The cup 10 is sealed on the upper side by a covering layer 16. The covering layer 16 can be a composite foil and can furthermore comprise, for example, a pull-off layer 61 (see above). The perforated covering layer 16 is, for example, made of a suitable plastic (for example polypropylene), and the pull-off layer is made of another suitable material (for example an aluminium-based foil). This pull-off layer 61 has properties which make it suitable as a gas barrier and liquid barrier. This means that a cup 10 filled with a preparation substance will keep well.

A static mixer 5 is present on the inside of the cup 10, which mixer can form part of the cup 10, which is produced in a single moulding step. This single moulding step means that the cup is inherently easy to sterilize with e.g. hydrogen peroxide, peracid etc. and is therefore extremely well suited for aseptic filling. Such a static mixer 5 contains no moving parts, which makes it simple to produce and reliable in operation. Using a cup with a static mixer means that a well-mixed product can still be delivered, without any finishing operation (stirring in the cup) being necessary.

By means of a cylindrical wall 6 of the static mixer 5, a first chamber part 25 is formed on the inside of the cup 10, further bounded by the inside of the shell 11 and the covering layer 16, which first chamber part can be filled (partially) with a preparation substance. The inside of the shell 11 is conically shaped in a large part of the first chamber part 25. This means that between a first radius r1 and a second radius r2 measured from the centre point of the cup 10 (indicated by the lines 30 and 31 respectively on the inside of the shell 11) the inside follows a straight path. The height of the inside of the shell 11 (measured from the underside of the cup 10, for example the surface formed by edge 14) between the lines 30 and 31 runs directly proportionally to the radius from the centre of the cup 10. The part of the shell 11 between the lines 30 and 31 is a conical surface, which forms a predetermined angle with the upper side of the cup 10 (for example indicated by the covering layer 16). The conical part of the inside of the shell 11 lies upstream of the static mixer 5.

Surprisingly, it has been found that such a shape of the inside of the shell 11 leads to the liquid that is flowing through perforations (see FIG. 5 below) in the covering layer 16 into the cup being mixed well with the preparation substance in the first chamber part 25. Experiments have shown that no residues of any kind of the preparation substance are left behind in the cup 10.

The static mixer 5 in the embodiment shown comprises at least one second chamber part 26, in which—just as in the first chamber part 25—water flows down from the upper side of the cup 10 through covering layer 16, as indicated by the arrows. The cup 10 can also be filled with a preparation substance in the second chamber part 26. Furthermore, the static mixer 5 comprises at least one riser channel 27, in which water mixed with the preparation substance coming from the first chamber part 25 and the at least one second chamber part 26 flows back up again. The static mixer 5 also comprises an outlet channel 28, which is in liquid communication with an outflow opening 24 for discharging the finished product.

The outflow opening 24 is shaped in such a way that a prepared product can flow out directly into a cup or mug, without further contact with a part of the preparation machine. This means that no residues of prepared products are left behind in the preparation machine, with the result that cross-contamination between different products prepared one after the other is prevented. It also prevents the preparation machine from becoming soiled.

In the embodiment shown in FIG. 1 an orientation rib 13 is provided on the inside of the shell 11 for each second chamber part 26. This indicates in which area in the static mixer 5 a second chamber part 26 is located. The function of said rib is important for filling of the cup and the orientation of the covering layer 16, as is explained in greater detail with reference to FIGS. 3 and 5 below.

A number of first openings 20 are provided between the first chamber part 25 and the second chamber part 26, at the edge where the static mixer 5 connects to the shell 11. A number of second openings are also provided between each second chamber part 26 and each riser channel 27, and a third opening 22 to the outlet channel 28 is provided for each riser channel. On the underside the second chamber parts 26 and riser channels 27 are sealed by the material of the shell 11. On the upper side the second chamber parts 26, riser channels 27 and outlet channel 28 are sealed by the covering layer 16.

The structure of the cup 10 with the abovementioned elements means that during use of the cup 10 a flow such as that indicated by the arrows inside the cup occurs in the cup 10. The combination of the elements ensures optimum flow and turbulence within the cup 10, with the result that good mixing of liquid and preparation substance can be achieved. The static mixer 5 according to this embodiment has multi-step turbulence generation, so that excellent mixing of liquid and preparation substance occurs.

The first and second openings 20, 21 remain sealed by the seal 15 during use. The first, second and third openings 20-22 are formed directly in the parts of the cup 10 concerned during the production process of the cup 10, for example by an injection moulding process or a process using compression moulds. After filling of the cup, the various elements that are important for the flow inside the cup are formed by means of the seal 15 and covering layer 16.

FIG. 2 shows the outflow part of the cup 10 in more detail, together with the seal 15. On the side of the outlet opening 24, the cup 10 is provided with a space 50. For this purpose, the static mixer 5 (as part of the shell 11) is provided with an outside wall 51 and a conically shaped outside or outlet part 52, which opens into the outlet opening 24. The conically shaped outlet part 52 is an inverted pointed shape, which is intended to pierce or perforate the seal 15 from the inside. The initial opening in the seal 15 is point-shaped, and is increasingly enlarged by stretching of the outlet part 52. It can also be so that the initial opening in the seal 15 is pointed, and the seal subsequently tears open further.

In one embodiment the seal 15 comprises a combination of two foils or films, for example laminated. One layer of the seal comprises a plastic film (for example polypropylene) on the side of the outlet opening 24, and a second layer comprises an aluminium film. The plastic film comprises a material which is softer than the material of the cup 10 (more particularly of the shell 11 and static mixer 5). This means that a good seal of the outlet opening 24 (for example during transport and storage) is obtained in a simple manner.

In one embodiment weakened parts 54 are provided in the seal 15, for example in the form of partial cuts of one or more layers of the seal 15. Furthermore, the seal 15 can be preformed as shown in the drawing, in which case a part is flat for sealing of the first and second openings 20, 21, and there is a central part which extends further into the space 51. In this way the outlet opening 24 is sealed in a more reliable manner.

It is also shown in FIG. 2 that the outlet opening 24 is provided with a rough internal surface, for example through the presence of additional grooves 53 along the inner circumference of the outlet opening 24. Through an increase in the circumferential line of the outflow surface of the outlet opening 24, this will ensure even better frothing for the prepared product.

The invention is explained in the above description on the basis of a number of embodiments with reference to the appended drawings. However, the scope of protection of this application also extends to possible changes and modifications which fall within the definitions of the terms used in the claims. For example, the shape of the cup is shown as circular, but it will be clear to the person skilled in the art that other shapes (square, inverted pyramid shape, oval) can also be used.

1. Cup for the preparation of a liquid product, comprising an inlet opening provided with a covering layer with liquid-permeable perforations for receiving a liquid suitable for a first preparation substance to be placed in the cup, an outlet opening for discharging the prepared beverage or dish, and a static mixer which is in liquid communication with the outlet opening, in which on the side of the inlet opening the cup is provided with a raised edge on the circumference which extends to a predetermined distance above the covering layer, so that a space for the accommodation of a body filled with a second preparation substance is produced on the upper side of the cup.

2. Cup according to claim 1, in which the cup is sealed on the upper side by a removable sealing layer.

3. Cup according to claim 2, in which the removable sealing layer (61) is provided with a projection extending beyond the raised edge.

4. Cup according to claim 1, in which the edge furthermore comprises a supporting edge for the body filled with a preparation substance.

5. Cup according to claim 1, in which the first preparation substance comprises a beverage concentrate.

6. Use of a cup according to claim 1 in a preparation machine provided with an accommodation space for accommodating the cup with a first preparation substance and a body filled with a second preparation substance, the preparation machine being equipped to convey a liquid through the body and the cup.
